(19) United States
(12) Patent Application Publication
(10) Pub. No.: US 2025/0224479 A1
(43) Pub. Date: Jul. 10, 2025

(54) METHODS FOR DETERMINING THE INTEGRITY OF POSITION INFORMATION

(71) Applicant: ZTE Corporation, Shenzhen (CN)

(72) Inventors: Di ZONG, Shenzhen (CN); Chuangxin JIANG, Shenzhen (CN); Yu PAN, Shenzhen (CN); Junpeng LOU, Shenzhen (CN)

(21) Appl. No.: 19/094,683

(22) Filed: Mar. 28, 2025

Related U.S. Application Data
(63) Continuation of application No. PCT/CN2022/122945, filed on Sep. 29, 2022.

(51) Int. Cl. G01S 5/02; H04W 24/10; H04W 56/00; H04W 64/00

(52) U.S. Cl. CPC G01S 5/0244; G01S 5/0236; H04W 24/10; H04W 56/001; H04W 64/00

(57) ABSTRACT

Positioning integrity is a measure of the trust in the accuracy of position-related data provided by a positioning system. Disclosed are techniques for identifying and quantifying error sources in radio access technology dependent positioning systems. In one aspect a method of wireless communication is disclosed. The method includes receiving location measurement results information that includes a position estimate of a wireless device and receiving an assistance information. The method further includes determining, based on the location results information and the assistance information, an integrity of the position estimate.

### CROSS-REFERENCE TO RELATED APPLICATIONS

This application is a continuation of, and claims priority to International Patent Application No. PCT/CN2022/122945, filed Sep. 29, 2022, the disclosure of which is incorporated herein by reference in its entirety.

### TECHNICAL FIELD

This patent document is directed to wireless communications

### BACKGROUND

In some wireless technologies including 5G new radio (NR), wireless device location is needed but location information is rarely precise. Various sources of error can reduce the accuracy of location information. New techniques are needed to evaluate these errors and their importance to system operation.

### SUMMARY

Positioning integrity is a measure of the trust in the accuracy of position-related data provided by a positioning system. Systems that monitor position integrity should provide timely warnings if the integrity of the positioning system position estimates fall below a threshold. Disclosed are techniques for identifying and quantifying error sources in radio access technology dependent positioning systems.

In one aspect a method of wireless communication is disclosed. The method includes receiving location measurement results information that includes a position estimate of a wireless device and receiving an assistance information. The method further includes determining, based on the location results information and the assistance information, an integrity of the position estimate.

In another aspect, another method of wireless communication is disclosed. The method includes receiving, at a wireless device, one or more location measurement results that include position estimates of the wireless device, and receiving, at the wireless device, one or more assistance information instances. The method further includes selecting, by the wireless device, from the received one or more location measurement results and the received one or more assistance information instances one or more selected location measurement results and selected assistance information instances to use for determining an integrity of the position estimate.

### BRIEF DESCRIPTION OF THE DRAWINGS

FIG. 1 depicts an example of information exchange for determining the integrity of position or location information using a local management function (LMF);

FIG. 2 depicts an example of information exchange for determining the integrity of position or location information using a wireless device (also referred to herein as a user equipment);

FIG. 3 depicts an example of information exchange where an LMF sends a measurement request message to configure one or more transmission reception points (TRPs) whose measurement results will be used for determining location information integrity;

FIG. 4 depicts an example of an information exchange for selecting TRPs;

FIG. 5A shows pseudocode for a downlink case using time difference on arrival (TDOA).

FIG. 5B shows pseudocode for a downlink case of angle of departure (AOD).

FIG. 5C shows pseudocode for a case of round trip time for multiple TRPs (MULTI-RTT).

FIG. 5D shows example of uplink angle of arrival assistance information;

FIG. 6A depicts an example of a process performed at a network node;

FIG. 6B depicts an example of a process performed at a wireless device;

FIG. 7 depicts an example of a system, in accordance with some example embodiments; and

FIG. 8 depicts an example of an apparatus, in accordance with some example embodiments.

### DETAILED DESCRIPTION

Positioning integrity is a measure of the trust in the accuracy of position-related data provided by a positioning system. The accuracy of position data is important to many radio systems including cellular radio systems such as 5G. Systems that monitor position integrity should also provide timely warnings if the integrity of the positioning system position data falls below a threshold. Techniques and systems for identifying and quantifying error sources in radio access technology dependent positioning systems are disclosed. Potential error sources for position data measurements of reference signal received power (RSRP), reference signal received path power (RSRPP) information, time-of-arrival/angle-of-arrival (TOA/AOA) information, and others. Disclosed are network side and wireless device side measurements that can be used for positioning integrity determination. The integrity of measurements from multiple transmission points (TRPs) is also disclosed.

In an example embodiment, the determining the integrity of GNSS positioning and assisted-GNSS positioning is disclosed. Positioning integrity provides a method to evaluate the trustworthiness of the position estimates. Previous work has been limited to the radio access technology (RAT) independent positioning methods. In some aspects, disclosed are techniques to expand into RAT-dependent positioning and how to identify the signaling transmitting procedures between a local management function (LMF) and UE for RAT-dependent positioning integrity determination.

Disclosed are aspects of a signaling procedure for RAT-Dependent positioning methods and some information that can be considered to be transmitted/reported during the procedure.

Positioning Integrity is a measure of the trust in the accuracy of the position-related data provided by the positioning system and the ability to provide timely and valid warnings to the location services (LCS) client when the positioning system does not meet one or more conditions for proper operation.

For statistical evaluation, PL is defined for measuring the real-time upper bound of the positioning error at the required degree of confidence, where the degree of confidence is determined by the TIR probability. It satisfies the following inequality:

$$Prob per unit of time [ ( ( PE > AL ) \& ( PL <= AL ) ) for longer than TTA ] < required TIR \qquad ( EQ . 1 )$$

NOTE: When the PL bounds the positioning error in the horizontal plane or on the vertical axis then it is called Horizontal Protection Level (HPL) or Vertical Protection Level (VPL) respectively.

NOTE: A specific equation for the PL is not specified as this is implementation-defined. For the PL to be considered valid, it must simply satisfy the inequality above.

Target Integrity Risk (TIR): The probability that the positioning error exceeds the Alert Limit (AL) without warning the user within the required Time-to-Alert (TTA). NOTE: The TIR is usually defined as a probability rate per some time unit (e.g., per hour, per second or per independent sample).

Alert Limit (AL): The maximum allowable positioning error such that the positioning system is available for the intended application. If the positioning error is beyond the AL, the positioning system should be declared unavailable for the intended application to prevent loss of positioning integrity. NOTE: When the AL bounds the positioning error in the horizontal plane or on the vertical axis then it is called Horizontal Alert Limit (HAL) or Vertical Alert Limit (VAL), respectively.

Time-to-Alert (TTA): The maximum allowable elapsed time from when the positioning error exceeds the Alert Limit (AL) until the function providing positioning integrity annunciates a corresponding alert.

Integrity Availability: The integrity availability is the percentage of time that the PL is below the required AL.

The relationship between the KPIs and the Protection Level (PL), and their impacts on the positioning solution are further examined below.

Protection Level (PL): The PL is a statistical upper-bound of the Positioning Error (PE) that ensures that, the probability per unit of time of the true error being greater than the AL and the PL being less than or equal to the AL, for longer than the TTA, is less than the required TIR.

### Example Embodiments

In some aspects, positioning integrity is a measure of the trust in the accuracy of the position-related data provided by the positioning system and the ability to provide timely and valid warnings to the LCS client when the positioning system does not fulfil the condition for intended operation.

Positioning integrity monitoring is already supported by global navigation satellite system (GNSS) service providers, and there is some standard for expanding the ecosystem of connected devices which can benefit from positioning integrity.

Hence, it is beneficial to extend the integrity procedure for A-GNSS to RAT dependent positioning including all wireless positioning methods defined in Rel-16 and 17, so that the integrity can enable applications or LCS client to make the correct decisions.

In this contribution, the following contents are included:
a) Delivery of measurement results to calculate integrity results
b) LPP/NRPPA signaling to deliver integrity results
c) The granularity of key information configured by LMF

### Example 1

In RAT-dependent positioning methods, two modes are supported: LMF based positioning methods and UE based positioning methods. The difference between the two modes lies in the necessity to report measurement results to LMF. For LMF based positioning methods, UE/TRPs are required to report measurement results to LMF and for UE based positioning methods, the contrary is the case.

According to the concept of integrity, these measurement results and related assistance data can assist in integrity results calculation. Hence, the integrity results will be calculated in different entity based on the mode.

In order to study the procedure to calculate and deliver the integrity results, we simply categorize the situations into the following cases

### CASE 1: LMF Based DL Positioning Methods

In this case, UE/TRPs are enabled to report one or more measurement instances (of RSTD, DL RSRP and UE Rx-Tx time difference measurements for UE, of RTOA, UL RSRP and/or gNB Rx-Tx time difference measurements for TRP) in a single measurement report to LMF.

Note: A measurement instance refers to one or more measurements, which can either be the same or different types, which are obtained from the same DL PRS resource(s), or the same UL SRS resource(s).

In some systems, there is a maximum of 64 TRPs for measurement report and 24 measurement instances in each measurement report containing multiple measurements, resulting in huge amount of measurement results reported. If all these results are utilized for integrity results calculation, high complexity and redundancy can not be avoided.

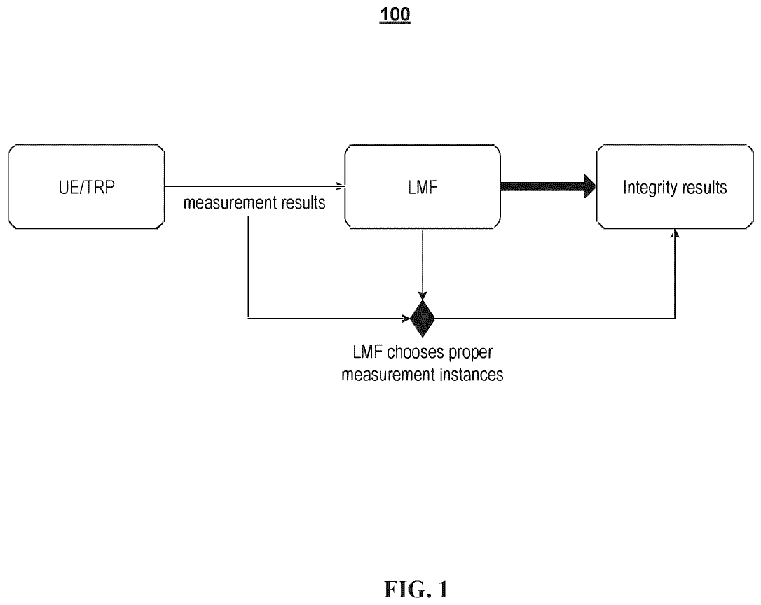

An LMF can receive measurement instances and choose which measurement instances to use to calculate the integrity results. FIG. 1 depicts an example procedure for determining integrity results. FIG. 1 shows the UE/TRP providing measurement results to the LMF. In the example of FIG. 1, the LMF chooses the proper measurement results for the measurement instances.

Criteria for choosing the measurement instances can include:
LMF ranks the instances with some measurement results such as:
   RSRP
   RSRPP
   TOA/AOA
LMF choose the best 5 instances of the measurement instances to calculate the integrity results

### CASE 2: UE Based DL Positioning Methods

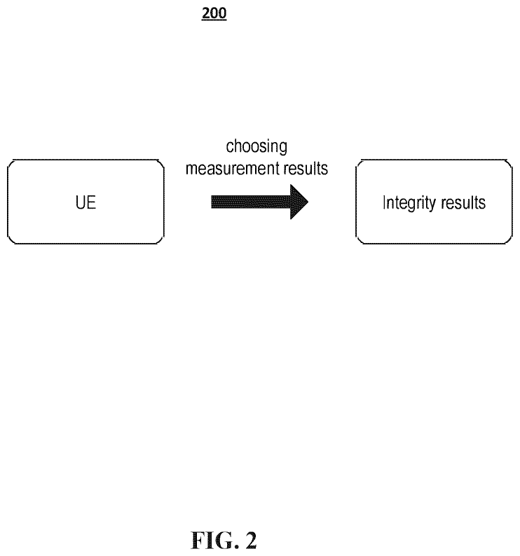

In this case, the integrity results can be calculated at the UE side. The UE receives measurement instances and chooses which of the measurement instances to use to calculate the integrity results. FIG. 2 depicts an example procedure for determining integrity results. In some embodiments consistent with FIG. 2, the UE can choose the measurement results used in determining the integrity results.

Criteria for choosing the measurement instances include:
LMF ranks the instances with some measurement results such as
   RSRP
   RSRPP
   TOA/AOA.
LMF chooses the best 5 instances of the measurement instances to calculate the integrity results

### Example 2

In UL positioning methods, the UE position is estimated based on measurements taken at different TRPs of uplink radio signals from UE, along with other assistance data.

In order to obtain precise integrity results, the LMF needs to know both measurement results and related assistance data. To reduce complexity, the LMF should also restrict the number of measurement instances assigned for integrity calculation.

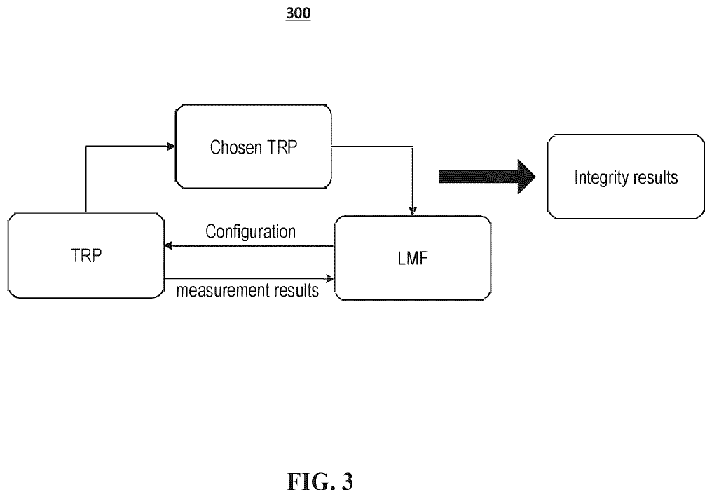

Apart from the method mentioned in Example 1, the LMF can also indicate the number of TRPs whose information transmitted to LMF will be assigned for integrity calculation. FIG. 3 depicts an example procedure for determining integrity results. In this case, the LMF will send a MEASUREMENT REQUEST message to configure selected TRPs whose measurement results will be used for determining the integrity results. Assistance data is provided by the selected TRPs. In some embodiments, the integrity results are determined by the UE. Table 1 details some parameter values. In Table 1, the field named maxnoIntegrityMeas refers to a maximum number of TRPs that are assigned for integrity calculation. For example, the number can be 5. After the corresponding TRPs feed back their measurement results, the LMF calculates the integrity results using the measurement results with corresponding labels.

TABLE 1

| | | | IE type and | | Assigned |
|---|---|---|---|---|---|
| IE/Group Name | Presence | Range | reference | Criticality | Criticality |
| Message Type | M | | 9.2.3 | YES | reject |
| NRPPa Transaction | M | | 9.2.4 | — | |
| ID | | | | | |
| LMF Measurement | M | | INTEGER | YES | reject |
| ID | | | (1 . . . 65536, . . . ) | | |
| TRP Measurement | | 1 | | YES | reject |
| Request List | | | | | |
| >TRP | | 1 . . . <maxnoofMeasTRPs> | | EACH | reject |
| Measurement | | | | | |
| Request Item | | | | | |
| TRP Measurement | | 1 | | YES | reject |
| Quantities | | | | | |
| >TRP | | 1 . . . <maxnoPosMeas> | | EACH | reject |
| Measurement | | | | | |
| Quantities Item | | | | | |
| TRP Integrity | | 1 | | YES | reject |
| Request | | | | | |
| >TRP Integrity | | 1 . . . <maxnoIntegrityMeas> | | EACH | reject |
| Item | | | | | |
| >>TRP ID for | M | | | — | |
| integrity | | | | | |

### Example 3

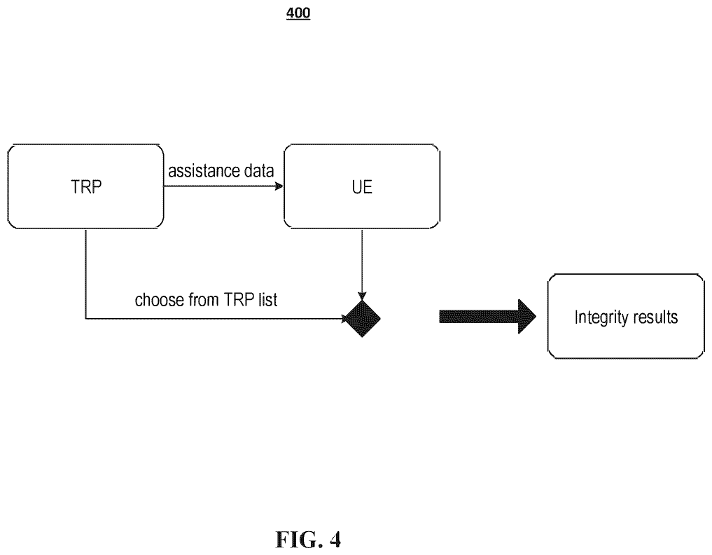

In addition to the measurement results, the related assistance data is also data that influences the integrity results. For the same reason, UE/LMF need to choose assistance data from part of the TRPs to calculate the integrity results. FIG. 4 shows an example procedure where the UE receives assistance data from TRPs chosen from a list of TRPs that is used to determine integrity results.

Selected criteria are used to choose the correct TRPs. The criteria can include one or more of the following:

LMF/UE can sort the TRPs according to some basic principle
LMF ranks the TRPs with the best measurement results. The measurement results include:
   RSRP
   RSRPP
   TOA/AOA
   Measurement quality
LMF sorts the TRP according to some assistance data.
   TRP location: the distance to reference TRP LMF chooses TRPs which are close to reference TRP
   Location uncertainty: horizontal uncertainty and vertical uncertainty LMF chooses TRPs with location uncertainty lower than a specific value
   Other assistance data.
Num of the chosen TRPs: the value is 5

### Example 4

In RAT-dependent positioning, a qualification flag can be reused to inform the computing entity if all kinds of measurement results or errors in assistance data are valid for integrity computation.

The qualification flags correspond to particular errors. If the condition provided in assistance data or measurement results can not be met during the valid time, the qualification flags should be set true and those corresponding measurement results or assistance data can not be used for integrity computation.

Qualification flags: If the condition provided in assistance data can not be met during the valid time, the TRP will not be reported for integrity computing and the qualification flags should be set true. The qualification flags correspond to particular errors.

The conditions provided in the assistance data or the measurement results can vary based on the positioning method. As such, the qualification flag may be configured per method.

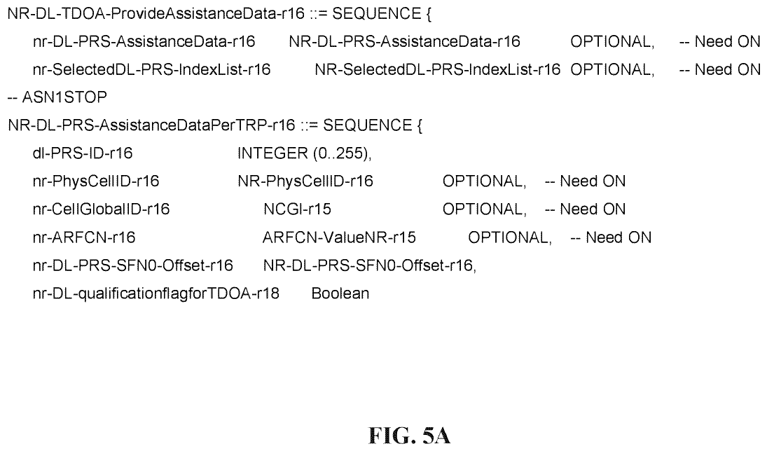

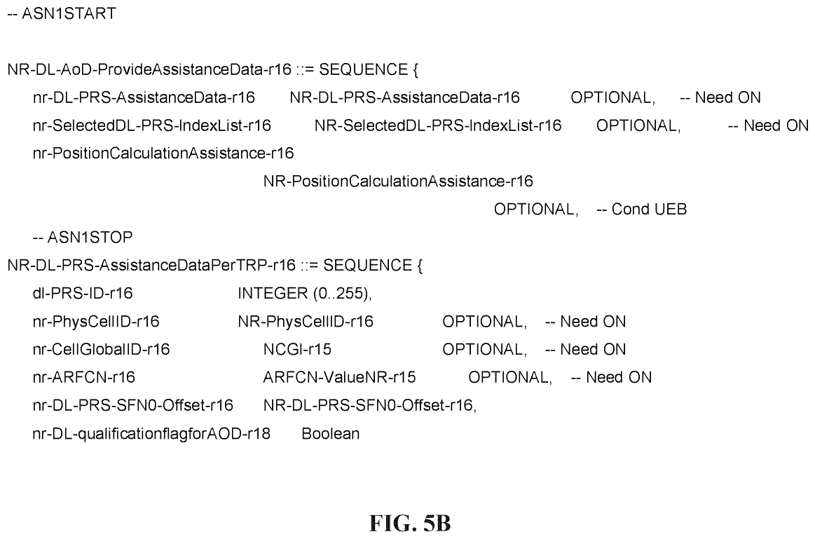

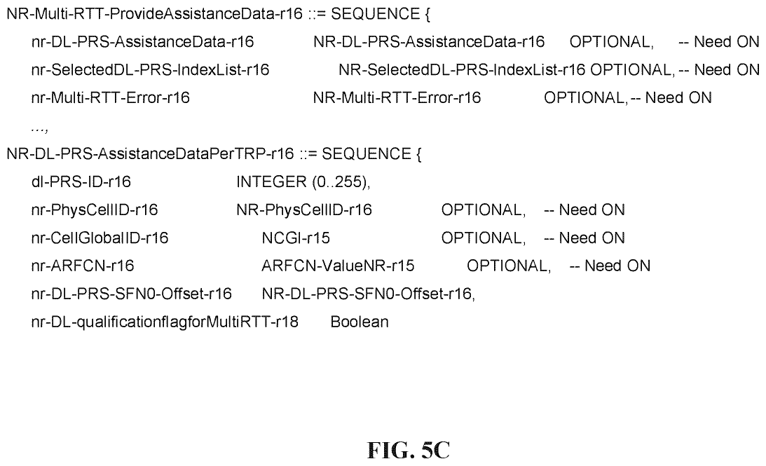

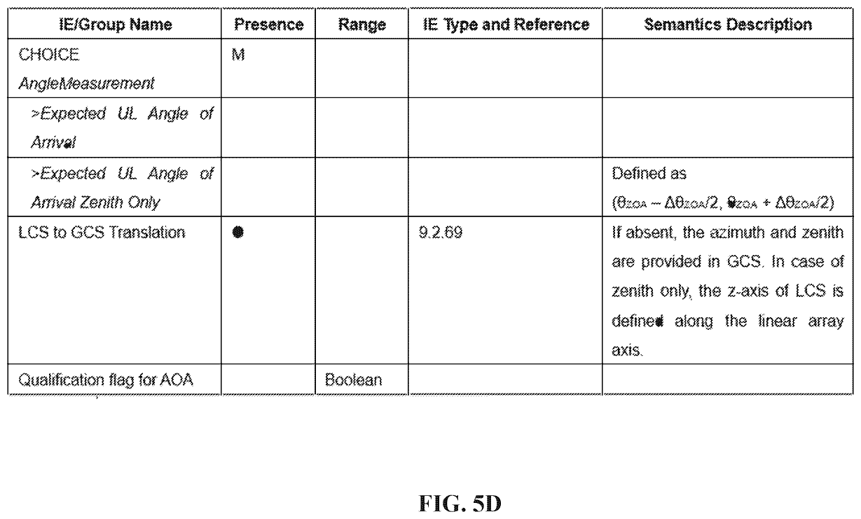

FIG. 5A shows pseudocode for a downlink case using time difference on arrival (TDOA). FIG. 5B shows pseudocode for a downlink case of angle of departure (AOD). FIG. 5C shows pseudocode for a case of round trip time for multiple TRPs (MULTI-RTT). FIG. 5D shows example of uplink angle of arrival assistance information.

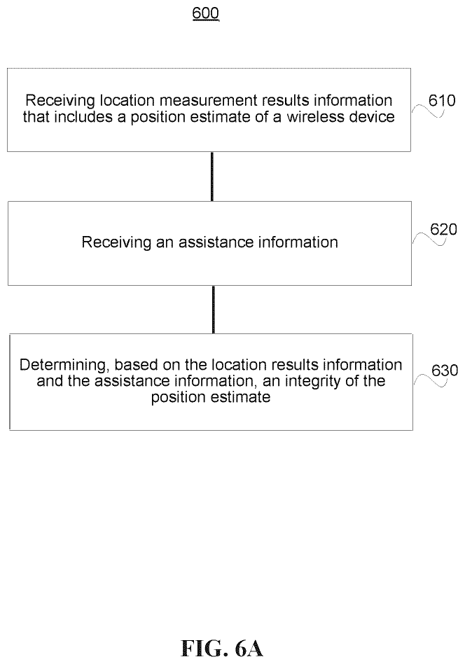

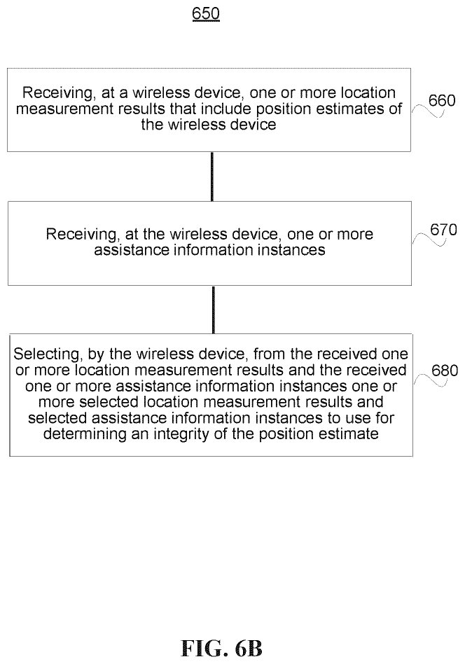

FIG. 6A depicts an example of a method of wireless communication performed at a network node, in accordance with some example embodiments. At 610, the method includes receiving location measurement results information that includes a position estimate of a wireless device. At 620, the method includes receiving an assistance information. At 630, the method includes determining, based on the location results information and the assistance information, an integrity of the position estimate.

FIG. 6B depicts an example of a method of wireless communication performed at a wireless device, in accordance with some example embodiments. At 660, the method includes receiving, at a wireless device, one or more location measurement results that include position estimates of the wireless device. At 670, the method includes receiving, at the wireless device, one or more assistance information instances. At 680, the method includes selecting, by the wireless device, from the received one or more location measurement results and the received one or more assistance information instances one or more selected location measurement results and selected assistance information instances to use for determining an integrity of the position estimate.

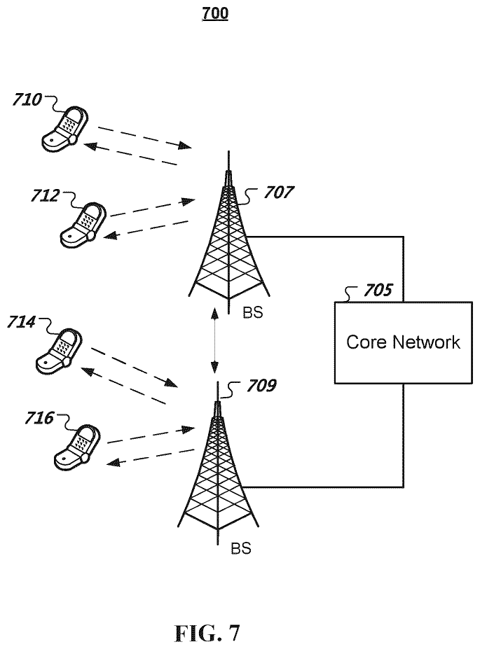

FIG. 7 shows an example of a wireless communication system (e.g., a 5G or NR cellular network) that includes one or more base stations 707, 709 and one or more wireless devices such as user equipment (UE) 710, 712, 714 and 716. In some embodiments, the UEs access the BS and core network 705 (e.g., the network) using a communication link to the network (sometimes called uplink direction, as depicted by dashed arrows pointing toward a base station), which then enables subsequent communication. In some embodiments, the BS sends information to the UEs (sometimes called downlink direction, as depicted by arrows from the base stations to the UEs), which then enables subsequent communication between the UEs and the BSs, shown by dashed arrows between the UEs and the BSs.

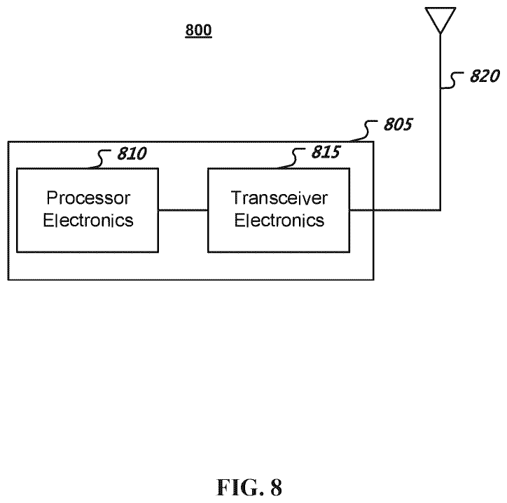

FIG. 8 shows an exemplary block diagram of a hardware platform 800 that may be a part of a network node (e.g., base station) or a communication device (e.g., a wireless device such as a user equipment (UE)). The hardware platform 800 includes at least one processor 810 and a memory 805 having instructions stored thereupon. The instructions upon execution by the processor 810 configure the hardware platform 800 to perform the operations described in FIGS. 1 to 7 in the various embodiments described in this patent document. The transceiver 815 transmits or sends information or data to another device. For example, a wireless device transmitter as part of transceiver 815 can send a message to a user equipment via antenna 820. The transceiver 815 receives information or data transmitted or sent by another device via antenna 820. For example, a wireless device receiver as part of transceiver 815 can receive a message from a network device via antenna 820.

### The Following Clauses Reflect Features of Some Preferred Embodiments.

Clause 1. A method of wireless communication, comprising: receiving location measurement results information that includes a position estimate of a wireless device; receiving an assistance information; and determining, based on the location results information and the assistance information, an integrity of the position estimate. This method may be performed by a network function such as a base station or another apparatus located in the network.

Clause 2. The method of clause 1, wherein the measurement results include one or more of: reference signal received power (RSRP) information; reference signal received path power (RSRPP) information; or time-of-arrival/angle-of-arrival (TOA/AOA) information.

Clause 3. The method of clause 1, further comprising: providing a warning to a location service (LCS) client when an error in a value of the position estimate exceeds a threshold value.

Clause 4. The method of clause 1, wherein the assistance information includes one or more of: a distance between a selected transmission reception point (TRP) and a reference TRP; or a location uncertainty of the selected TRP.

Clause 5. The method of clause 1, wherein, position estimate is determined by a radio access technology (RAT) dependent positioning method.

Clause 6. The method of clause 1, wherein the method is performed by a local management function (LMF) of a network node.

Clause 7. The method of clause 6, wherein the position estimate is an LMF based downlink positioning technique.

Clause 8. The method of clause 1, wherein the receiving the position estimate is received from the wireless device.

Clause 9. The method of clause 6, further comprising: sending, by the LMF, to a selected transmission reception point (TRP) a request indicating that the selected TRP is to send the location measurement result information and the assistance information to the LMF.

Clause 10. The method of clause 6, further comprising: ranking, by the LMF, a plurality of TRPs by their associated measurement result information.

Clause 11. The method of clause 10, further comprising: sorting, by the LMF, the plurality of TRPs by their associated assistance information; and selecting a TRP based on the ranking and the sorting.

Clause 12. A method of wireless communication, comprising: receiving, at a wireless device, one or more location measurement results that include position estimates of the wireless device; receiving, at the wireless device, one or more assistance information instances; and selecting, by the wireless device, from the received one or more location measurement results and the received one or more assistance information instances one or more selected location measurement results and selected assistance information instances to use for determining an integrity of the position estimate.

Clause 13. The method of clause 12, wherein the measurement results include one or more of: reference signal received power (RSRP) information; reference signal received path power (RSRPP) information; or time-of-arrival/angle-of-arrival (TOA/AOA) information.

Clause 14. The method of clause 12, wherein the assistance information includes one or more of: a distance between a selected transmission reception point (TRP) and a reference TRP; or a location uncertainty of the selected TRP.

Clause 15. The method of clause 12, wherein, position estimate is

determined by a radio access technology (RAT) dependent positioning method.

Clause 16. An apparatus comprising a processor configured to perform any one or more of clauses 1 to 15.

Clause 17. A computer-readable medium including instructions that when executed by a processor perform a method recited in any one or more of clauses 1 to 15.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of wireless communication, comprising:
receiving location measurement results information that includes a position estimate of a wireless device;
receiving an assistance information; and
determining, based on the location measurement results information and the assistance information, an integrity of the position estimate.

2. The method of claim 1, wherein the location measurement results information comprises one or more of:
reference signal received power (RSRP) information;
reference signal received path power (RSRPP) information; or
time-of-arrival/angle-of-arrival (TOA/AOA) information.

3. The method of claim 1, further comprising:
providing a warning to a location service (LCS) client when an error in a value of the position estimate exceeds a threshold value.

4. The method of claim 1, wherein the assistance information comprises one or more of:
a distance between a selected transmission reception point (TRP) and a reference TRP; or
a location uncertainty of the selected TRP.

5. The method of claim 1, wherein the position estimate is determined by a radio access technology (RAT) dependent positioning method.

6. The method of claim 1, wherein the method is performed by a local management function (LMF) of a network node.

7. The method of claim 6, wherein the position estimate is an LMF based downlink positioning technique.

8. The method of claim 1, wherein the position estimate is received from the wireless device.

9. The method of claim 6, further comprising:
sending, by the LMF, to a selected transmission reception point (TRP) a request indicating that the selected TRP is to send the location measurement result information and the assistance information to the LMF.

10. The method of claim 6, further comprising:
ranking, by the LMF, a plurality of TRPs by their associated measurement result information.

11. The method of claim 10, further comprising:
sorting, by the LMF, the plurality of TRPs by their associated assistance information; and
selecting, by the LMF, a TRP based on the ranking and the sorting.

12. A method of wireless communication, comprising:
receiving, by a wireless device, one or more location measurement results that comprise position estimates of the wireless device;
receiving, by the wireless device, one or more assistance information instances; and
selecting, by the wireless device, from the received one or more location measurement results and the received one or more assistance information instances one or more selected location measurement results and selected assistance information instances for determining an integrity of the position estimate.

13. The method of claim 12, wherein the one or more location measurement results comprise one or more of:
reference signal received power (RSRP) information;
reference signal received path power (RSRPP) information; or
time-of-arrival/angle-of-arrival (TOA/AOA) information.

14. The method of claim 12, wherein the one or more assistance information instances comprise one or more of:
a distance between a selected transmission reception point (TRP) and a reference TRP; or
a location uncertainty of the selected TRP.

15. The method of claim 12, wherein the position estimate is determined by a radio access technology (RAT) dependent positioning method.

16. The method of claim 12, further comprising:
providing a warning to a location service (LCS) client when an error in a value of the position estimate exceeds a threshold value.

17. An apparatus comprising:
a transceiver; and
at least one processor,
wherein the transceiver is configured to receive location measurement results information that comprises a position estimate of a wireless device and an assistance information, and
wherein the at least one processor is configured to determine, based on the location measurement results information and the assistance information, an integrity of the position estimate.

18. A non-volatile computer-readable medium including instructions that when executed by at least one processor causes the at least one processor to perform the method of claim 1.

19. An apparatus comprising:
a transceiver; and
at least one processor,
wherein the transceiver is configured to receive, at a wireless device, one or more location measurement results that comprise position estimates of the wireless device and one or more assistance information instances, and
wherein the at least one processor is configured to select from the received one or more location measurement results and the received one or more assistance information instances one or more selected location measurement results and one or more selected assistance information instances for determining an integrity of the position estimate.

20. A non-volatile computer-readable medium including instructions that when executed by at least one processor causes the at least one processor to perform the method of claim 12.
